(19) United States
(12) Patent Application Publication
(10) Pub. No.: US 2014/0125983 A1
(43) Pub. Date: May 8, 2014

(54) INTERFEROMETERY ON A PLANAR SUBSTRATE

(71) Applicants: Arthur Nitkowski, Ithaca, NY (US); Arsen Hajian, Toronto (CA)

(72) Inventors: Arthur Nitkowski, Ithaca, NY (US); Arsen Hajian, Toronto (CA)

(73) Assignee: TORNADO MEDICAL SYSTEMS, INC., Toronto, Ontario (CA)

(21) Appl. No.: 14/122,773

(22) PCT Filed: May 30, 2012
(86) PCT No.: PCT/CA2012/000525

§ 371 Date: Nov. 27, 2013

Related U.S. Application Data
(60) Provisional application No. 61/491,620, filed on May 31, 2011.

(51) Int. Cl. G01J 9/02

(52) U.S. Cl. CPC G01J 9/02
USPC 356/450

(57) ABSTRACT

An interferometer comprising a planar substrate is provided. The interferometer has a splitter formed on the planar substrate to split a received optical signal, a sample arm formed on the planar substrate to receive a first portion of the split optical signal and direct the first portion toward a sample, a reference arm formed on the planar substrate to receive a second portion of the split optical signal, and a detector element to receive an interferogram generated by interfering the second portion of the split optical signal with a received sample signal generated by the first portion of the split signal interacting with the sample.

### RELATED APPLICATIONS

This application claims priority from U.S. Provisional Application No. 61/491,620 filed May 31, 2011, the contents of which are herein incorporated by reference.

### FIELD OF INVENTION

This invention relates to interferometry, and more specifically relates to apparatus and methods for generating an interferogram with an interferometer formed on a planar substrate.

### SUMMARY OF THE INVENTION

In an aspect of the invention an interferometer is provided, the interferometer comprising: a planar substrate; a splitter formed on the planar substrate to split a received optical signal; a sample arm formed on the planar substrate to receive a first portion of the split optical signal and direct the first portion toward a sample; a reference arm formed on the planar substrate to receive a second portion of the split optical signal; and a detector element to receive an interferogram generated by interfering the second portion of the split optical signal with a received sample signal generated by the first portion of the split signal interacting with the sample.

In some embodiments, the delay can be introduced between the first and second portion of the split optical signals and in additional embodiments, the delay can be introduced in the reference arm.

In some embodiments, the interferometer can further comprise a controllable delay element operable to adjust the delay. In some embodiments, the reference arm and sample arm can be waveguides having an effective refractive index, and in some embodiments, the controllable delay element can adjust the refractive index of a portion of the reference arm to introduce the delay. In some embodiments, the controllable delay element can adjust the refractive index of the reference arm by changing the temperature of the portion of the reference arm, while in other embodiments, the controllable delay element can adjust the refractive index of the reference arm by the electro-optic effect.

In some embodiments, the reference arm can be a serpentine shape, and in some embodiments, the reference arm and/or sample arm can be comprised of materials that are transparent in the wavelength range of the received optical signal, such as silicon, silicon nitride, doped glass, other polymers or other suitable material for guiding light in a wavelength range of interest.

In some embodiments, the interferometer can further comprise a dispersive element for receiving the interferogram and generating a plurality of narrowband interferograms representative of a spectra of the interferogram and additional detector elements each to receive the plurality of narrowband interferograms.

In some embodiments, the detector element of the interferometer can be formed on the planar substrate. In some embodiments, the interferometer can further comprise an optical source which can be formed on the planar substrate for generating the optical signal and in other embodiments, the interferometer can further comprise an input mode converter for connecting with a fiber input to receive the optical signal.

In some embodiments, the interferometer can further comprise a sample return arm formed on the planar substrate for receiving the received sample signal and a recombiner formed on the substrate optically connected to the sample return arm and reference arm for interfering the returned sample signal and second portion of the split signal to generate the interferogram. In some embodiments, the recombiner can generate a second interferogram by interfering the returned sample signal and the second portion of the split signal and the second interferogram is received by a second detector array to determine an optical path length difference and in other embodiments, the recombiner can generate a second interferogram by interfering the returned sample signal and the second portion of the split signal, and the second interferogram being out of phase with the interferogram and the second interferogram is received by a second detector array to filter noise from the first interferogram generating a third filtered interferogram.

In some embodiments, the splitter of interferometer can be a directional coupler and the interferometer can further comprise a reflective element optically connected to an end of the reference arm for reflecting the second portion of the split signal back towards the directional coupler, wherein the directional coupler is configured to interfere the received sample signal and reflected second portion of the split signal to generate the interferogram.

In some embodiments, the directional coupler can generate a second interferogram by interfering the received sample signal and reflected second portion of the split signal, and the second interferogram is received by a second detector element to determine an optical path length difference and in other embodiments, the directional coupler can generate a second interferogram by interfering the received sample signal and reflected second portion of the split signal, and the second interferogram is received by a second detector array to filter noise from the first interferogram generating a third filtered interferogram.

In further embodiments, the interferometer can further comprise a tunable light source capable of generating the received optical signal.

### BRIEF DESCRIPTION OF THE DRAWINGS

For a better understanding of embodiments of the system and methods described herein, and to show more clearly how they may be carried into effect, reference will be made by way of example, to the accompanying drawings in which:

FIG. 1 shows an embodiment of a time domain interferometer formed on a planar substrate;

FIG. 2 shows an alternative embodiment of a time domain interferometer formed on a planar substrate;

FIG. 3 shows an embodiment of a time-domain and Fourier-domain interferometer in optical communication with a spectrometer;

FIG. 4 shows an embodiment of a Fourier domain interferometer in optical communication with a spectrometer; and

FIG. 5 shows an embodiment of a source swept interferometer having a tunable optical source.

### DETAILED DESCRIPTION

Interferometers are apparatus and systems generally used with interferometry techniques, which are generally based on the superposition of electromagnetic waves (such as light) to extract information or perform analysis. In a typical example, an interferometer takes a single beam of light, splits it into two beams (or arms) by a beam splitter, to generate a reference beam and sample beam of light with the same frequency and phase. An interferometer can shift the phase of one of the waves by a known amount so that when the two split waves are re-combined, or superimposed, an interferogram can be produced which can depict output wave amplitude as a function of delay between the input arms, or equivalently the optical path difference between the input arms. An interferogram can be analyzed to obtain certain information depending on the application. For example, if one of the split beams is directed to and reflected off a sample, an interferogram can be analyzed to determine certain properties of the sample by examining how the light has been altered through contact with the sample.

By way of example, Optical Coherence Tomography (OCT) is an imaging technique that uses the interference properties of low-coherence light to generate real-time, cross sectional and three dimensional images. Not unlike ultra-sound, which measures reflecting sound waves or echoes, OCT measures the reflections of back scattered light passing through a sample to generate detailed surface and/or sub-surface images.

OCT is an interferometric technique that splits and recombines a broadband light source to detect the differences between superimposed waves. Unlike ultrasound technology, which measures the time delay or changes of a generated sound wave, interferometry is based on measurement of changes, such as phase delay and intensity, of reflected light. Since the high speed of light makes the direct measurement of light delay generally impracticable, interferometry is instead used to compare the reflected light to a reference beam of light that has traveled through a known reference path (of known length and delay).

An OCT system generally includes several paths, or arms, such as source, sample, reference and return arms. The source arm emits (or receives and directs) a broadband light beam comprised of various wavelengths of lights. The source light enters the interferometer and is split by a beam splitter into a sample arm and a reference arm. In some imaging systems, the phase of the reference beam is delayed, generally by increasing the optical path distance of the sample arm, and after interaction with a sample, the beam can be reflected back to interfere with the reference beam. When the two beams of light are recombined with one another, a resulting interferogram is recorded. The introduction of the delay allows, for example, depth analysis of the sample when the reference beam is delayed by a known path length equal to the depth of the sample at a particular point.

In applications as medical imaging tools, such using interferometers to scan a sample, OCT systems tend to be hindered by limitations in resolution, sample penetration depth, signal to noise ratio and image acquisition time. By way of example, penetration depth of OCT can be determined by emission wavelength and source power. The wavelength tends to be the primary determinant of penetration, based on the absorption and/or scattering characteristics of tissue. Absorption of most live tissue tends to increase with increasing wavelength. In contrast, longer wavelengths of light reduce scattering and improve penetration depth. In the final balance, near infrared wavelengths are often used in OCT. In general, penetration depths are generally limited to a few mm, depending on the wavelength and optical properties of the sample, which is significantly lower than depths achieved in other technologies, such as ultrasound.

Since OCT uses low coherence light interference, OCT tends to provide high resolution imaging data. In OCT 3-dimensional (3D) imaging, resolution can be defined in both the transverse and axial directions. One useful property of OCT is that the axial and lateral resolution are independent of one another. The axial resolution is thus limited by the coherence length of the illumination source, which is inversely proportional to the spectral bandwidth. The lateral resolution is a limited either by an insufficient transversal sampling rate or/and the size of the probe beam diameter.

When performing OCT (or other medical imaging using interferometry), the signal generally will unavoidably contains noise. The source of this noise may be found in the light sources, the scanning reference arms, the absorbing medium, the detectors or the electronic measurement systems used in optical spectrometry. Speckle noise that arises from the interference between coherent waves backscattered from nearby uncorrelated scatterers in a sample can sometimes be the dominant source of noise in OCT images.

In most interferometric systems, the optical path length of the reference arm is modulated by mechanical means such as a rotating mirror. By way of example, the time-domain OCT approach in current systems tends to be hampered by the relatively complicated optical and mechanical designs needed to scan extremely small delays at extremely fast rates in order to achieve real-time imaging. These mechanical components limit the speed at which imaging can be completed. Furthermore, these components increase the size of imaging instrumentation and thus limiting their effectiveness in-vivo. As a result, it is desirable to provide an interferometer capable of introducing delay using fewer mechanical and alternate components capable of much faster processing times. Additionally, it is desirable to have interferometers capable of use in near real-time imaging, where path delay can tend to be introduced nearly instantaneously. Furthermore, it is desirable to have an interferometer containing components of a size suitable for use in in-vivo analysis.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Furthermore, this description is not to be considered as limiting the scope of the embodiments described herein in any way, but rather as merely describing the implementation of the various embodiments described herein.

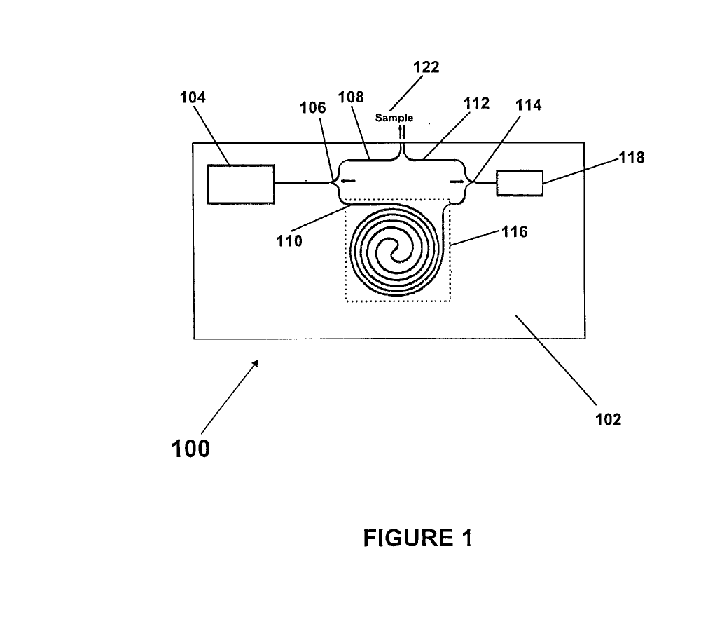

Referring to FIG. 1, interferometer 100 having components formed on planar substrate 102 is shown. Interferometer 100 has optical source 104 which generates an optical signal. In the embodiment shown, optical source 104 is formed on planar substrate 102; however, skilled persons will appreciate that in some embodiments, optical source 104 can be external to planar substrate and can be optically coupled to planar substrate 102 by, for example, a fiber optic cable coupled to a waveguide formed on planar substrate 102. In some embodiments, optical source 104 can be a superluminescent diode, fiber amplifier, femtosecond pulsed laser, supercontinuum source or any other broadband source of light in the near infrared or other part of the electromagnetic spectrum.

Interferometer 100 further includes splitter 106, formed on planar substrate 102, which receives the optical signal generated by optical source 104 and splits the optical signal into a first portion and a second portion, the first portion directed to sample path, or arm, 108 and the second portion directed to reference path, or arm, 110. In some embodiments, splitter 106 can have a broad bandwidth and can operate with a flat 50:50 splitting ratio for all wavelengths of interest, which can tend to provide low optical signal losses. In some embodiments, splitter 106 can have a splitting ratio other than 50:50, such that the power in each arm is equal at the recombiner 114 to optimize the fringe contrast in the interference signal. Splitter 106 can be a y-splitter, multimode interference splitter, directional coupler, Mach-Zehnder splitter or other optical beam splitter capable of splitting a received optical signal and directing the split signals towards two or more paths.

In the embodiment, the first portion of the split optical signal output from splitter 106 is directed to sample arm 108, which is formed on planar substrate 102. Sample arm 108 directs the first portion of the split optical signal toward sample 122. In some embodiments, the first portion of the split signal can be directed by sample arm 106 to the edge of planar substrate 102 where it can be coupled to an optical fiber, or other appropriate light transmitting element, and directed to interact with sample 122, for example, by striking sample 122, penetrating a surface or surfaces of the sample 122, and reflecting or dispersing off sample 122 to generate a return optical signal. In such embodiments, the return optical signal generated by the first portion of the split optical signal interacting with sample 122 is received by return arm 112, which is formed on planar substrate 102. Skilled persons will appreciate that in other embodiments, the first portion of the split optical signal can be directed to the edge of planar substrate 102 which can be placed next to sample 122 without the use of an optical fiber or other light transmitting element.

The second portion of the split optical signal output from splitter 106 is directed to reference arm 110, which is formed on planar substrate 102. In the embodiment shown, reference arm 110 has a curved or serpentine path which can provide a compact footprint on planar substrate 102 of reference arm 110; however, skilled persons will understand that other shapes can provide also compact footprints, such as other spirals or raster scanned shapes. Skilled persons will additionally appreciate that reference arm 110 can be linear shaped or formed in a straight line. In some embodiments, the total optical length of reference arm 110 can match the optical path of sample arm 108 and return arm 112 including the distance traveled to sample 122 and back again.

In the embodiment shown, interferometer 100 further includes controllable delay element 116, which can introduce an optical delay in the second portion of the split optical signal directed through reference arm 110. In some embodiments, controllable delay element 116 is formed on planar substrate 102 and in other embodiments, controllable delay element 116 is positioned proximate to planar substrate 102 and reference arm 110 such that it can introduce the optical delay.

In the embodiment shown, a delay (Δx) is introduced by varying the refractive index of the material of reference arm 110. Depending on the material of reference arm 110, this can be accomplished, for example, by varying the temperature of reference arm 110 (or a portion of reference arm 110) or by the electro-optic effect. For example, in some embodiments, controllable delay element can include a heating element, a cooling element, diodes or electrodes. In other embodiments, designing interferometer 100 where the optical path length of reference arm 110 is greater than or less than the total optical path of sample arm 100 and return arm 112, including the distance traveled to sample 122 and back again, can introduce a delay.

Interferometer 100 further includes recombiner 114, formed on planar substrate 102, which receives the second portion of the split optical signal from reference arm 110 and the return optical signal (the sample signal generated by the first portion of the split optical signal interacting with sample 122, discussed above) and interferes these signals to generate an interferogram. In some embodiments, recombiner 114 can have a broad bandwidth and can operate with a flat 50:50 splitting ratio for all wavelengths of interest which can provide low optical signal losses. Recombiner 114 can be an asymmetrical directional coupler, an adiabatic coupling via dress states or other optical beam recombiner capable of generating an interferogram by interfering two received optical signals.

In some embodiments, recombiner 114 can produce a single output, which, in such embodiments, combines or interferes the received beams to form a single beam projecting an interferogram. In other embodiments, recombiner 114 can produce two outputs, each output projecting an interferogram, the additional output interferogram being detected by a second detector array. In such embodiments, the two outputs can be 180° out of phase, where when one output is at a null value the other is at a peak value. In such embodiments the two outputs can generate a third output having a higher signal-to-noise ratio than the two outputs generated by such recombiner 114. In such embodiments fluctuations between the two outputs of recombiner 114 other than the 180° out of phase differences can be interpreted as noise, such as fluctuations introduced by instrumentation of interferometer 100. In such embodiments, the two outputs of recombiner 114 can be represented as interferograms I₁ and I₂. By dividing the difference between interferograms I₁ and I₂ by the sum of the interferograms I₁ and I₂ in accordance with the following equation: I₃=(I₁−I₂)/(I₁+I₂), the fluctuations between the two interferograms I₁ and I₂ can be filtered, removing the noise, tending to result in a third interferogram (I₃), which is representative of the first interferogram I₁ where noise in I₁ has been filtered, tending to result in the third interferogram 1₃ having a higher signal-to-noise ratio than the first interferogram I₁.

Interferometer 100 further includes detector 118 which receives the interferogram generated by recombiner 114 for analysis. For example, in some embodiments, detector 118 can be an integrated waveguide photodetector and can measure reflectance information for sample 122 at the specific point in sample 122 where the total optical path difference of the signals received by detector 118 are equal, in such embodiments tending to detect stronger interference fringes.

In some embodiments, where interferometer 100 is used in an optical coherence tomography (OCT) system, depth information of sample 122 can be determined by scanning the optical path length of reference arm 110 and, in such embodiments, by changing the refractive index and delay of reference arm 110 with delay element 116. In such embodiments detector 118 measures the generated interferogram for each of the optical path lengths that can be selected by changing the refractive index of reference arm 110.

In other embodiments, sample 122 or planar substrate 102 can be moved (either manually or through automated mechanical means) to provide transverse sample information and in such embodiments, a 3-dimensional (3D) image of sample 122 can be generated. In some embodiments, sample 122 can be moved back and forth laterally during scanning in, for example, a 2-dimensional raster-scanning pattern. During such scanning, delay element 116 can be cycled through a range of delays (such as, for example changing the refractive index of reference arm 110 to generate a variety of interferograms for each scanned portion of sample 122 representative of reflectivity as a function of depth for each such scanned portion). In such embodiments a processor (not shown) can compile and render the individual depth data into a 3D image of sample 122 for the scanned portion. Skilled persons will appreciate that scanning geometries other than a 2-dimensional roster scan can be used to obtain a 3D image of sample. Skilled persons will additionally appreciate that in other embodiments sample 122 can remain in a fixed position while interferometer 100 is repositioned during scanning.

In the embodiment shown in FIG. 1, sample arm 108, reference arm 110, return arm 112 and optical connections between optical source 104 and splitter 106, and connection between recombiner 114 and detector 118, are waveguides formed on planar substrate 102. In some embodiments, these waveguides can be comprised of materials that are transparent in the near infrared spectrum in the ranges typically used in OCT systems, in some embodiments being 800 nm, 1050 nm or 1300 nm spectral bands; however, skilled persons will appreciate that in other embodiments alternative materials can be chosen that are appropriate for a particular wavelength or range of wavelengths of light. In some embodiments, it can be preferable that the materials used to form waveguides have a high refractive index, which can confine light and enable more compact photonic components as compared to materials having low index contrast. In some embodiments, waveguides can be comprised of silicon nitride, silicon oxynitride, silicon, SU8, doped glass, other polymers or another suitable material.

In some embodiments, the elements of interferometer 100 can be formed on planar substrate 102 using electron-beam lithography; however, skilled persons will appreciate that photonic circuits can be fabricated by other methods, such as deep UV lithography.

In embodiments where interferometer 100 is formed on planar substrate 102 using electron-beam lithography and where waveguides and other photonic elements on planar substrate 102 are silicon nitride, a standard silicon wafer can be used having several microns of silicon dioxide thermally grown on a top surface. In some embodiments, a thickness of 3-4 microns of silicon dioxide can be used to implement interferometer 100; however, skilled persons will appreciate that other thicknesses can be used and may be appropriately chosen based on the wavelength range of optical input signals to be analyzed and/or processed with interferometer 100.

In such embodiments, silicon nitride can then be deposited onto planar substrate 102, and in some embodiments, a few hundred nanometers of stoichiometric silicon nitride can be deposited using low pressure chemical vapour deposition. An adhesion promotion layer, such as Surpass 3000™, can additionally be applied which can prevent delamination of the electron beam resist which can then be spin coated on to the planar substrate to a thickness of approximately 300 nanometers. A conductive layer can be spun onto the planar substrate 102 which can prevent stitching errors due to charging.

Planar substrate 102 can be patterned using an electron-beam patterning tool at an appropriate current to expose the resist and after being exposed, planar substrate 102 can be rinsed with deionizing water to remove the conducting layer. In some embodiments planar substrate 102 can be developed with a 300 MIF process to remove unexposed resist. A descum process can be used with a barrel etcher to remove residual resist and the pattern in the resist can be reflowed, in some embodiments for several minutes, with a hot plate to smooth out any surface roughness.

Planar substrate 102 can be etched using inductively coupled reactive ion etching (ICP RIE) with a CHF₃/O₂ recipe. The resist mask used for etching can then be removed in a resist hot strip bath which contains heated solvents.

Planar substrate 102 can then be plasma cleaned to remove any resist remaining and can be annealed in a furnace oxide tube, in some embodiments at 1200° C. for three hours. This can tend to reduce material absorption losses in embodiments where optical source 104 generates an optical signal at wavelengths that are near infrared.

Planar substrate 102 can then be covered in oxide, in some embodiments using high temperature oxide deposited in furnace tubes or by plasma enhanced chemical vapour deposition, and lift-off fabrication techniques can be used to define controllable delay element 116, which in some embodiments a heater made of evaporated NiCr. Planar substrate 102 can then be diced and the end facets can be polished which can improve coupling of waveguides and other optical elements formed on the planar substrate 102.

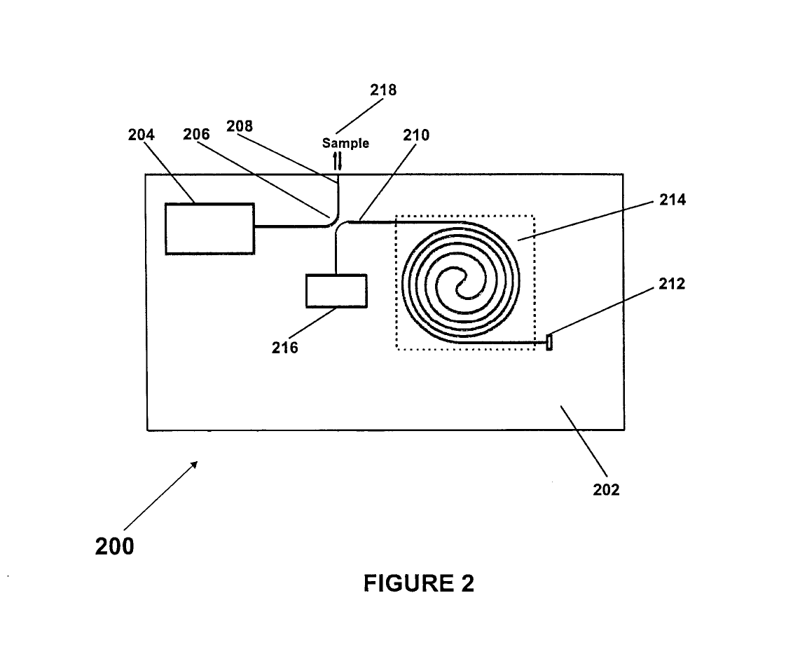

Referring now to FIG. 2, interferometer 200 having components formed on planar substrate 202 is shown. Interferometer 200 has optical source 204 which generates an optical signal. In the embodiment shown, optical source 204 is formed on planar substrate 202; however, skilled persons will appreciate that in some embodiments, optical source 204 can be external to planar substrate 202 and can be optically coupled to planar substrate 202 by, for example, a fiber optic cable coupled to a waveguide formed on planar substrate 202. In some embodiments optical source 204 can be a superluminescent diode, fiber amplifier, femtosecond pulsed laser, supercontinuum source or any other broadband source or near infrared light source.

Interferometer 200 further includes directional coupler 206, formed on planar substrate 202, which receives the optical signal generated by optical source 204 and splits the optical signal into a first portion and second portion. The first portion is directed to sample path, or arm, 208 and the second portion is directed to reference path, or arm, 210. In some embodiments, directional coupler 206 can have a wide operating bandpass and can be a beam splitter such as one typically used in a Michelson interferometer. In such embodiments, directional coupler 206 can operate with a 50:50 splitting ratio for all wavelengths of interest which can tend to provide low optical signal losses.

In the embodiment, the first portion of the split optical signal output from directional coupler 206 is directed to sample arm 208, which is formed on planar substrate 202. Sample arm 208 directs the first portion of the split signal to sample 218. In some embodiments, the first portion of the split signal can be directed by sample arm 208 to the edge of planar substrate 202, where it can be coupled to an optical fiber, or other appropriate light transmitting element, and is directed to interact with sample 218, for example, by striking sample 218, penetrating a surface or surfaces of sample 218, and reflecting or dispersing off sample 218 to generate a return optical signal. In such embodiments, the return optical signal generated by the first portion of the split optical signal interacting with sample 218 can again be received by sample arm 208. Skilled persons will appreciate that in other embodiments, the first portion of the split optical signal can be directed to the edge of planar substrate 202 which can be placed next to sample 218, without the use of an optical fiber or other light transmitting element.

The second portion of the split optical signal output from directional coupler 206 is directed to reference arm 210, which is formed on planar substrate 202. In the embodiment shown, reference arm 210 has a curved or serpentine path which can provide a compact footprint on planar substrate 202 of reference arm 210; however, skilled persons will understand that other shapes can also provide compact footprints, such as other spirals or raster scanned shapes. Skilled persons will additionally appreciate that in some embodiments reference arm 210 can be linear or straight line shaped. In some embodiments the total length of reference arm 210 can match the optical path traversed by light reaching sample 218.

The second portion of the split optical signal output from coupler 206 is directed through reference arm 210 and is reflected back along the same path of reference arm 210 by reflective element 212. In some embodiments, reflective element 212 can be an integrated mirror formed on substrate 202, such as a Bragg reflector and in other embodiments can be a deposited metal coating. The reflected signal generated by reflective element 212 is directed back towards directional coupler 206 through reference arm 210.

In the embodiment shown, interferometer 200 further includes controllable delay element 214, which can introduce an optical delay in the second portion of the split optical signal directed through reference arm 210. In some embodiments, controllable delay element 214 is formed on planar substrate 202 and in other embodiments, controllable delay element 214 is positioned proximate to planar substrate 202 and reference arm 210 at an appropriate position so as to be operable to introduce the optical delay.

In the embodiment shown, a delay is introduced by controllable delay element 214 by varying the refractive index of the material of reference arm 210. Depending on the material of reference arm 210, this can be accomplished, for example, by varying the temperature of reference arm 210 or by the electro-optic effect. For example, in some embodiments controllable delay element 214 can be a heating element, a cooling element, or diodes or electrodes.

The return optical signal generated by the first portion of the split signal interacting with sample 218 is received by sample arm 208 and directed back toward directional coupler 206 through sample arm 208. As discussed above, the reflected signal off reflective element 212 is additionally directed back to directional coupler 206 through reference arm 210. Directional coupler 206 generates and outputs an interferogram by interfering the return signal and the reflected signal. In the embodiment shown, directional coupler 206 produces two interferogram outputs, one interferogram output directed towards detector 216 and a second interferogram output directed towards optical source 204.

In the embodiment shown, detector 216, which in some embodiments can be formed on planar substrate 202, receives one of the interferograms generated by directional coupler 206 for analysis. For example, in some embodiments, detector 216 can be an integrated waveguide photo detector and can measure reflectance information for sample 218 at the specific point in sample 218 where the total path lengths of the signals received by detector 206 measured from optical source 204 are equal, in such embodiments tending to detect stronger interference fringes. For example, in some embodiments, if strong reflections are generated by a scanned portion of sample 218 where the total path lengths are equal, detector 216 can tend to receive a stronger interferogram comprising constructive and destructive interference.

In the embodiment shown, the second output generated by directional coupler 206 can be used to measure the optical path length, and in some embodiments can be used to filter noise, generated by, for example, interference at the fringes, of the first output received by detector 216. In the embodiment shown in FIG. 2, the second interferogram generated by directional coupler 206 directed towards optical source 204 can be picked off by an optical element (not shown) and in such embodiments this second interferogram can be 180° out of phase with the interferogram directed towards detector 216. In some embodiments, as discussed above, a filtered interferogram can be generated, representative of interferogram directed towards detector 216, tending to have a higher signal-to-noise ratio. In such embodiments the filtered interferogram can be generated based on the equation: I₃=(I₁−I₂)/(I₁+I₂), where I₁ is the interferogram directed towards detector 216, I₂ is the picked off interferogram directed towards optical source 204 and I₃ is the filtered interferogram.

In the embodiment shown in FIG. 2, where interferometer 200 is used in an OCT system, depth information of sample 218 can be determined by scanning the optical path length of reference arm 210 and in such embodiments, by changing the refractive index and delay in reference arm 210 with delay element 214. In other embodiments sample 218 or planar substrate 202 can be moved or repositioned to provide transverse sample information and in such embodiments, a 3D image of sample 218 can be generated. For example, as discussed above, sample 218 can be scanned using raster-scanning pattern methods where delay element 214 can be cycled through a range of delays (changes to the refractive index of reference arm 210) to generate a plurality of interferograms for analysis to render depth data to generate a 3D image.

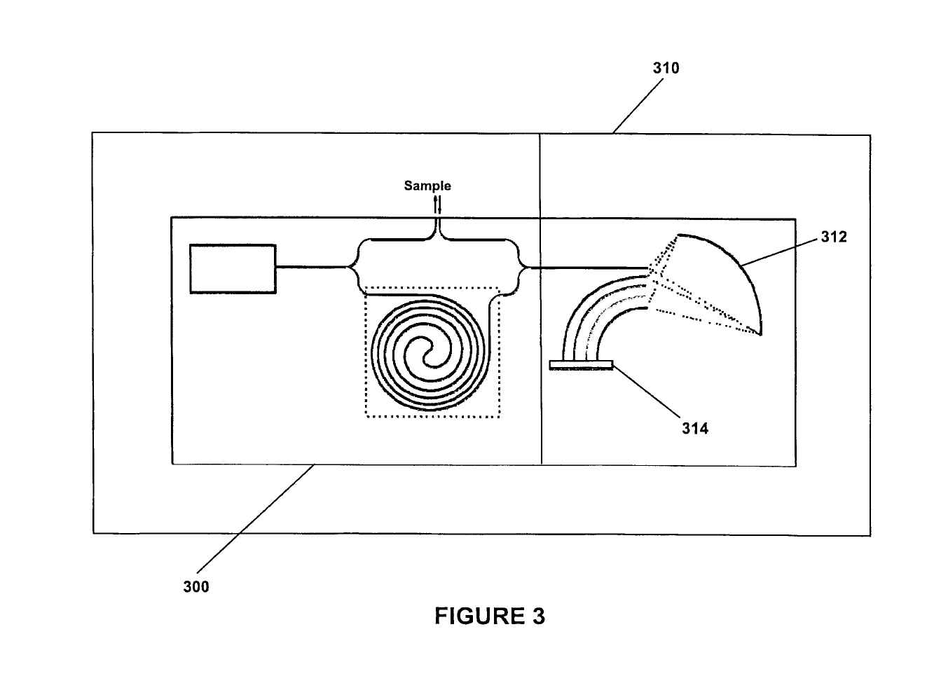

Referring to FIG. 3, interferometer 300 is shown. Interferometer 300 as shown is optically connected to spectrometer 310. In the embodiment shown interferometer 300 is substantially similar to the interferometer 100 shown in FIG. 1, and operates in a substantially similar manner by generating an interferogram and being operable to adjust the delay on an optical signal directed through a reference arm using a controllable delay element, such as a heating element, cooling element, diode or electrode, which varies the refractive index of the material of the reference arm (or a portion of the reference arm).

In the embodiment shown in FIG. 3, the interferogram generated by interferometer 300 is received by spectrometer 310 for analysis. Spectrometer 310 comprises dispersive element 312 and detector array 314. Dispersive element 312 outputs a plurality of narrowband interferograms that are representative of the spectra of the interferogram output by interferometer 300. Each of the narrowband interferograms are received by detector array 314 which, in some embodiments, can be connected to a processor (not shown) and can, by Fourier transformation, analyze each of the plurality of narrowband interferograms, to obtain, analyze and/or process the spectra of the interferogram generated by interferometer 300.

In some embodiments, spectrometer 310 can be formed on the same planar substrate as interferometer 300. In other embodiments, spectrometer 310 can be independent of interferometer 300 but can be optically connected to interferometer 300, for example, by an optical fiber cable, or other appropriate light transmitting element. In other embodiments, spectrometer 310 can be positioned proximate to interferometer 300 to receive the interferogram generated and output by interferometer 300.

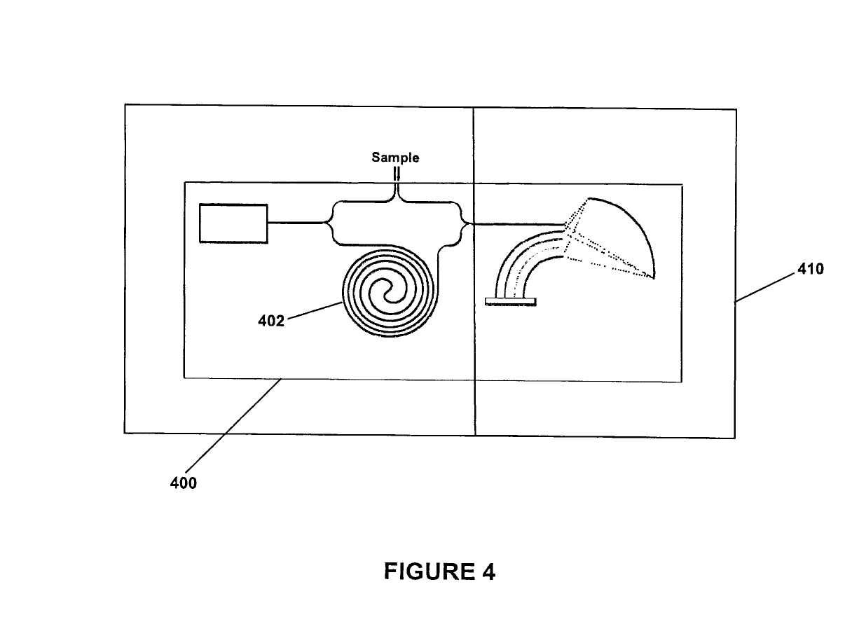

With reference to FIG. 4 interferometer 400 is shown. In the embodiment shown interferometer 400 is optically connected to spectrometer 410. In the embodiment shown, spectrometer 410 is substantially similar to the spectrometer 310 described above with reference to FIG. 3 and operates in a substantially similar manner to the spectrometer described above in FIG. 3; however, interferometer 400 does not include a controllable delay element for introducing an optical delay in the second portion of the split optical signal directed through reference arm 402. Instead, in the embodiment shown, a delay is introduced in reference arm 402 based on the total length of reference arm 402 as compared to the total optical path travelled by the first portion of the split optical signal and the return signal generated when the first portion of the split optical signal interacts with a sample. In such embodiments, the length of reference arm 402 is predetermined prior to the construction of interferometer 400. In some embodiments, where interferometer 400 is used for OCT imaging, the length of reference arm 402 can be predetermined such that the zero value optical path difference between the split optical signals is just in front of the sample to be imaged or at the deepest penetration point. In such embodiments, scanning a sample from the zero optical path difference to a delay of 1-2 centimeters (cm) of optical path difference can be sufficient for OCT applications.

In the embodiment shown in FIG. 4, as discussed above, spectrometer 410 operates in a substantially similar manner as spectrometer 310 described with reference to FIG. 3, discussed above. Spectrometer 410 receives the interferogram generated by interferometer 400 and outputs a plurality of narrowband interferograms representative of the spectra of the interferogram output by interferometer 400. Each of the narrowband interferograms is received by a detector array to obtain, analyze and/or process the spectra of the interferogram generated by interferometer 400. In embodiments having a fixed delay, such as the embodiment shown in FIG. 4, scans of a sample, for example lateral raster-scans across the sample, can tend to be completed at a faster rate as a delay element is not being continuously adjusted, at the cost of having the ability to adjust the delay which can be advantageous in other applications.

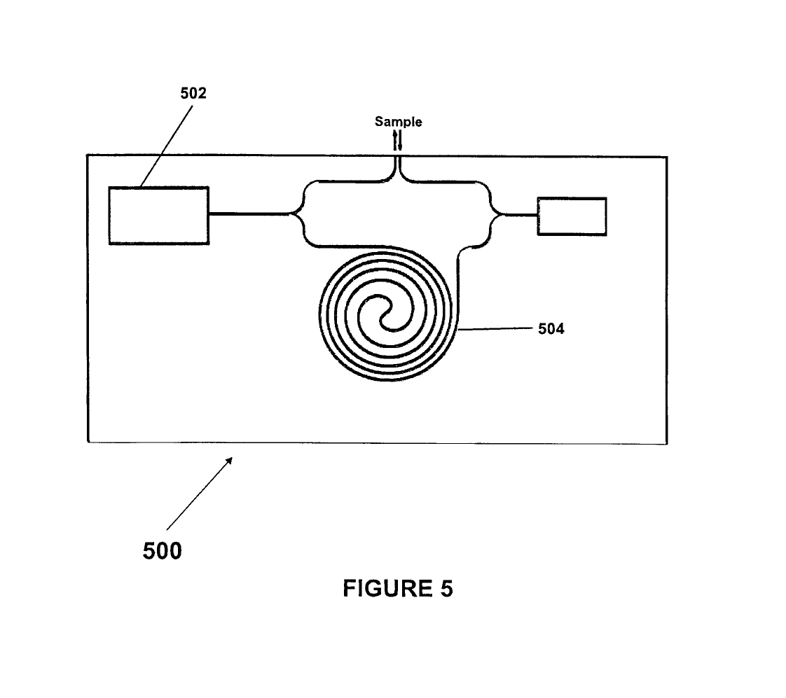

With reference to FIG. 5 interferometer 500 is shown. Interferometer 500 is substantially similar to the interferometer 100 described with reference to FIG. 1 above; however, interferometer 500 does not have a controllable delay element to introduce an optical delay in the second portion of the split optical signal directed through reference arm 504. Instead, on the embodiment shown in FIG. 5, a delay can be introduced based on the total length of reference arm 504 as compared to the total optical path travelled by the first portion of the split optical signal and the return signal generated when the first portion of the split optical signal interacts with a sample. In such embodiments, the length of reference arm 504 can be predetermined when interferometer 500 is constructed (for example, as discussed above for interferometer 400 with reference to FIG. 4).

In addition, interferometer 500 shown in FIG. 5 includes tunable light source 502. In such embodiments, a specific wavelength of light can be selected and/or predetermined prior to use of interferometer 500 and tunable light source 502 can be set or controlled to output the predetermined wavelength of light.

In the embodiments where interferometer 500 is used in an OCT application, swept source OCT scanning can be conducted with interferometer 500. In such systems tunable light source 502 can output varying spectral bands of light and for each spectrum, and interferometer 500 can generate an interferogram measurable by a detector. In such systems interferogram generated can be processed and/or analyzed by a processor (not shown) for analysis of a sample scanned with interferometer 500, for example by Fourier transform analysis to retrieve a depth reflectivity profile of a scanned substance or sample.

In the embodiments described herein, including those embodiments described with reference to FIGS. 2-5, elements of the interferometers described that can be used for transmitting optical signals on a planar substrate can be waveguides, which, as described above with reference to FIG. 1, can be comprised of materials which are transparent in the near infrared spectrum in ranges typically used in OCT systems, in some embodiments being 800 nm, 1050 nm or 1300 nm spectral bands; however, skilled persons will appreciate that in other embodiments alternative materials can be chosen that are appropriate for a particular wavelength or range of wavelengths of light. In some embodiments, it can be preferable that the materials used to form such waveguides have a high refractive index, which can tend to confine light and can provide compact photonic components as compared to materials having low index contrast. In some embodiments, waveguides can be comprised of silicon nitride, silicon oxynitride, silicon, SU8, doped glass, other polymers or another suitable material.

Additionally, in the embodiments described herein, including those embodiments described with reference to FIGS. 2-5, the interferometers can be formed on the planar substrate using electron-beam lithography and, where waveguides and other photonic elements on the planar substrate of the interferometer are silicon nitride, a standard silicon wafer can be used having several microns of silicon dioxide thermally grown on a top surface.

As described above, in the embodiments described herein, the interferometers and/or spectrometers described herein can be formed on the planar substrate using electron-beam lithography in the manner and using the methods described above; however, skilled persons will appreciate that photonic circuits can be fabricated by other methods, such as deep UV lithography.

The present invention has been described with regard to specific embodiments. However, it will be obvious to persons skilled in the art that a number of variants and modifications can be made without departing from the scope of the invention as described herein.

1. An interferometer comprising:
a planar substrate;
a splitter formed on the planar substrate to split a received optical signal;
a sample arm formed on the planar substrate to receive a first portion of the split optical signal and direct the first portion toward a sample;
a reference arm formed on the planar substrate to receive a second portion of the split optical signal; and
a detector element to receive an interferogram generated by interfering the second portion of the split optical signal with a received sample signal generated by the first portion of the split signal interacting with the sample.

2. The interferometer of claim 1, wherein a delay is introduced between the first and second portion of the split optical signals.

3. The interferometer of claim 2, wherein the delay is introduced in the reference arm.

4. The interferometer of claim 3, further comprising a controllable delay element operable to adjust the delay.

5. The interferometer of claim 4, wherein the reference arm and sample arm are waveguides having an effective refractive index.

6. The interferometer of claim 5, wherein the controllable delay element adjusts the refractive index of a portion of the reference arm to introduce the delay.

7. The interferometer of claim 6, wherein the controllable delay element adjusts the refractive index of the reference arm by changing the temperature of the portion of the reference arm.

8. The interferometer of claim 6, wherein the controllable delay element adjusts the refractive index of the reference arm by the electro-optic effect.

9. The interferometer of claim 5, wherein the reference arm is serpentine shape.

10. The interferometer of claim 5, wherein the reference arm and sample arm are comprised of material that is transparent in the wavelength range of the received optical signal.

11. The interferometer of claim 10, wherein the material is silicon, silicon oxynitride, silicon nitride, doped glass or a polymer.

12. The interferometer of claim 1, further comprising a dispersive element for receiving the interferogram and generating a plurality of narrowband interferograms representative of a spectra of the interferogram and additional detector elements each to receive the plurality of narrowband interferograms.

13. The interferometer of claim 1, wherein the detector element is formed on the planar substrate.

14. The interferometer of claim 13, further comprising an optical source formed on the planar substrate for generating the optical signal.

15. The interferometer of claim 13, further comprising an input mode converter for connecting with a fiber input to receive the optical signal.

16. The interferometer of claim 1, further comprising a sample return arm formed on the planar substrate for receiving the received sample signal and a recombiner formed on the substrate optically connected to the sample return arm and reference arm for interfering the returned sample signal and second portion of the split signal to generate the interferogram.

17. The interferometer of claim 16, wherein the recombiner generates a second interferogram by interfering the returned sample signal and the second portion of the split signal and the second interferogram is received by a second detector array to determine an optical path length difference.

18. The interferometer of claim 16, wherein the recombiner generates a second interferogram by interfering the returned sample signal and the second portion of the split signal, and the second interferogram being out of phase with the interferogram and the second interferogram is received by a second detector array to filter noise from the first interferogram generating a third filtered interferogram.

19. The interferometer of claim 1, wherein the splitter is a directional coupler and the interferometer further comprises a reflective element optically connected to an end of the reference arm for reflecting the second portion of the split signal back towards the directional coupler, wherein the directional coupler is configured to interfere the received sample signal and reflected second portion of the split signal to generate the interferogram.

20. The interferometer of claim 19 wherein the directional coupler generates a second interferogram by interfering the received sample signal and reflected second portion of the split signal, and the second interferogram is received by a second detector element to determine an optical path length difference.

21. The interferometer of claim 19, wherein the directional coupler generates a second interferogram by interfering the received sample signal and reflected second portion of the split signal, and the second interferogram is received by a second detector array to filter noise from the first interferogram generating a third filtered interferogram.

22. The interferogram of claim 1, further comprising a tunable light source capable of generating the received optical signal.
